(19) United States
(12) Patent Application Publication
(10) Pub. No.: US 2014/0279042 A1
(43) Pub. Date: Sep. 18, 2014

(54) Social Media Purchase Offers

(71) Applicant: RAPP WORLDWIDE INC., New York, NY (US)

(72) Inventors: Craig Allen Elimeliah, New York, NY (US); Juan Camilo La Cruz-Smith, Brooklyn, NY (US)

(73) Assignee: Rapp Worldwide Inc., New York, NY (US)

(21) Appl. No.: 13/841,331

(22) Filed: Mar. 15, 2013

(51) Int. Cl. G06Q 30/02; G06Q 50/00

(52) U.S. Cl. CPC G06Q 30/0269; G06Q 50/01
USPC 705/14.66

(57) ABSTRACT

Methods, systems and computer-readable storage mediums encoded with computer programs executed by one or more processors for providing social media purchase offers are disclosed. An offer strategy construct including: a markup tag associated with a social media platform (SMP), a purchase offer, and criteria for providing the purchase offer in response to a post to the SMP is received. The SMP is monitored for posts corresponding to the markup tag. User info is extracted from the SMP upon a detection that a particular post corresponds to the markup tag. It is determined whether the user info satisfies the criteria. The purchase offer is provided to the user associated with the post as determined from the user info upon a determination that the user info satisfies the criteria.

### CROSS-REFERENCE TO RELATED APPLICATIONS

This application is related to co-pending application titled “Social Media Branding,” (U.S. application Ser. No. to be assigned, Atty Docket Number 3349.0020000, filed Mar. 15, 2013), which is hereby incorporated by reference.

### FIELD

Embodiments herein relate generally to social media offers for purchase.

### BACKGROUND

Social media is a growing focus for companies and other organizations that are trying develop, expand, or define a brand for a product, service, or feature. Using social media, companies are able to interact with customers or potential customers on a more personal level than may be done through traditional advertising. From an end user point of view, social media allows users to converse with other users about any topics found mutually interesting or noteworthy.

Many companies try to interact directly with the people who are connected to them through a social media platform (SMP) and become part of the conversations being had by users, particularly when those users are conversing about the company or its products. However, tracking social media posts about the company could become a labor-intensive task as millions of SMP users have conversations about the company or its products.

### BRIEF SUMMARY

An embodiment of the invention as described in this specification may include a method. An offer strategy construct including: a markup tag associated with a social media platform (SMP), a purchase offer, and criteria for providing the purchase offer in response to a post to the SMP is received. The SMP is monitored for posts corresponding to the markup tag. User info is extracted from the SMP upon a detection that a particular post corresponds to the markup tag. It is determined whether the user info satisfies the criteria. The purchase offer is provided to the user associated with the post as determined from the user info upon a determination that the user info satisfies the criteria.

Other embodiments of this aspect include corresponding systems, apparatus, and computer programs, configured to perform the actions of the methods, encoded on computer storage devices. Further embodiments, features, and advantages, as well as the structure and operation of the various embodiments, are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a block diagram illustrating a system for providing social media purchase offers, according to an example embodiment.

FIG. 2 is a flow chart of a process of a system for providing social media purchase offers, according to an example embodiment.

FIG. 3 is a system diagram that can be used to embody or implement embodiments described herein.

### DETAILED DESCRIPTION

While the present disclosure makes reference to illustrative embodiments for particular applications, it should be understood that embodiments are not limited thereto. Other embodiments are possible, and modifications can be made to the embodiments within the spirit and scope of the teachings herein, and additional fields in which the embodiments would be of significant utility. Further, when a particular feature, structure, or characteristic is described in connection with an embodiment, it is submitted that it is within the knowledge of one skilled in the relevant art to affect such feature, structure, or characteristic in connection with other embodiments whether or not explicitly described.

The owner or sponsor of a product, line of products, or brand may want to provide offers, discounts, or promote the sale of its own products using social media. For example, users may post content about the product or the product sponsor. It would be beneficial for the sponsor to be able to, in real-time or near real-time, monitor such posts and provide purchase offers to users to incentivize the purchase of one or more products. For example, a manufacturer of a brand of desserts may desire to promote the sale of the desert lines by providing discounts, coupons, or other purchase offers to users who post images or text (e.g., content) on a social media platform about any of the brand of desserts.

The ability to identify, and respond to posts inquiring about the purchase or sale of a product or any other form of commercial intent may have marketing advantages for the sponsor that may increase brand awareness and promote sales. For example, it may allow the sponsor of a product to keep customers or potential customers interested in the brand, by interacting with such users in real-time, while the users have shown interest in the brand and incentivize their use, trial, or purchase of products with discounts or other purchase offers.

FIG. 1 is a block diagram illustrating a system 100 for social media purchase offers, according to an example embodiment. In system 100, a media branding system (MBS) 102 may monitor posts 108 on a social media platform (SMP) 106 and provide purchase offers 116 based on an offer strategy construct (hereinafter, “offer strategy”) 104. SMh 106 may be any social media platform, such as, for example and without limitation, Twitter®, Pinterest®, Facebook®, LinkedIn®, etc.

Offer strategy 104 may include selections of how a sponsor 105 desires to brand, market, or otherwise promote sales of a product 107 using social media, or more particularly one or more SMPs 106. Sponsor 105 may be an individual, company, or other entity that is involved with the promotion, marketing, advertising, branding, or trial or sale of (hereinafter collectively referred to as “offering”) of product 107. Sponsor 105 may for example, include an owner, manufacturer; advertising agency, or distributor of product 107.

Product 107 may be any item or product, line of products, brand, service, entity (including sponsor 105), or other marketable feature to be offered by sponsor 105 through social media based on offer strategy 104. For example, a shoe company (sponsor 105) may develop offer strategy 104 for offering a new line of sneakers (product 107), or a political campaign (sponsor 105) may seek to encourage donations (using offer strategy 104) to support a politician, political party, or particular issue (product 107). Or, for example, a municipality (sponsor 105) may seek to offer itself (product 107) to increase tourism or otherwise attract people with discounts on travel, stays, or meals with offer strategy 104.

Offer strategy 104 may include any decisions or strategies regarding what factors or issues, such as social media posts 108, media 109, markup tags 112, or user into 124, are relevant to offering product 107 and how and when purchase offers 116 for product 107 are to be provided. In an embodiment, offer strategy 104 may also include the use of user data or information available outside of SMP 106. For example, sponsor 105 may be a website that has access to a purchase history of a particular user 111, which may be used either in conjunction with or in lieu of user info 124, to customize purchase offers 116. Or, for example, other publicly available data may be used as well to customize offer strategy 104 or define parameters for criteria 118.

Purchase offer 116 may include any advertisement, coupon, trials, discount, sale, special, rewards program, or other offering for product 107. Purchase offer 116 may be any offer or promotion intended to incentivize the purchase, use, sale, or trial of product 107 by a user 111 of SMP 106. For example, purchase offer 116 may be a coupon or discount to purchase product 107 as provided to user 111 who provides or posts post 108 to SMP 106 about sponsor 105 and/or product 107 and satisfies criteria 118. Or, for example, purchase offer 116 may include a product or service giveaway, free trial, sweepstakes, or raffle entry. User 111 may be any individual, company, collaboration, or other user who has created an account for SMP 106 or is otherwise authorized to access or post to SMP 106.

Offer strategy 104 may be, for example, part of an overall marketing or sales strategy for offering product 107, which may include other traditional types of advertising or product offerings as well. Offer strategy 104 may include various options or selections, as will be discussed in greater detail below that may be made by sponsor 105 for offering product 107 through or using one or more SMPs 106.

MBS 102 may monitor SMP 106 for posts 108 relevant to product 107 as defined in accordance with offer strategy 104. A monitor 130 may monitor SMP 106 for posts 108 that are identified as being relevant to product 107 as defined in accordance with offer strategy 104. Upon detection of a relevant post 108 by monitor 130, an extractor 132 may extract or request content from SMP 106 associated with the post 108, including for example user info 124 and media 109. Post 108 may include, for example, any searchable, classifiable, or otherwise detectable activity on SMP 106.

The content extracted or requested by extractor 132 may be used by a verifier 134 to verify whether criteria 118 for providing purchase offer 116 is satisfied. Verifier 134 may determine whether purchase offer 116 is to be provided to user 111. In an embodiment, verifier 134, from criteria 118, may also determine the amount of purchase offer 116. For example, criteria 118 may include different parameters for receiving discounts (purchase offers 116) of varying amounts or types. For example, a user 111 who is a known customer (e.g., from user info 124A) may be provided a small discount to purchase product 107, while a new customer (e.g., user 111) may be provided a larger discount, or vice versa. Criteria 118 may include parameters by which verifier 134 may determine whether purchase offer 116 is provided to user 111 associated with post 108, and the size and type of purchase offer 116 to be provided to user 111. In an embodiment, criteria 118 may include additional parameters by which monitor 130 may monitor SMP 106 for relevant posts 108, or extractor 132 may request relevant information from SMP 106.

In an embodiment, verifier 134 may determine the type of purchase offer 116 and compute the value or amount of purchase offer 116, if applicable, based on criteria 118. Users 111 who have user info 124 that meet varying requirements of criteria 118 may be provided with different types or values of purchase offers 116. For example, users 111 in different locations (e.g., as determined from location 124B) may be provided different types (e.g., coupon, trial offer, sales notice, rewards points) or values (percentage discount, monetary discount, 2 for 1 purchase promotion) of purchase offers 116.

Verifier 134 may then provide purchase offer 116 to user 111. Verifier 134 may post a post 108 on SMP 106, send a SMS or text message to, e-mail instant message, physically mail, or otherwise provide, send, or transmit purchase offer 116 for use or redemption by user 111. For example, verifier 134 may post purchase offer 116 on SMP 106 for user 111. However, purchase offer 116 may also be visible or otherwise accessible to other members or users within the social network (e.g., based on connections 124C) of the user 111 and may be usable by the other members as well, or may be for the exclusive use or view of user 111.

In an embodiment, location 124B may be used by sponsor 105 to customize offer strategy 104. Sponsor 105 may provide or define different offer strategies 104 for different geographic locations. For example, upon detecting post 108 is relevant to offer strategy 104 by monitor 130, monitor 130 or verifier 134 may determine whether location 12413 corresponds to a geographic location that may be specified within criteria 118. Criteria 118 may include particular geographic locations (e.g., radiuses, cities, states, countries, or other geographic designations or parameters) that are of particular interest for purchase offer 116 or that are to be excluded for receiving purchase offer 116. Then for example, verifier 134 may deter nine the value of purchase offer 116 based on location 124B, if available.

As another example, sponsor 105 may have retail stores located in various geographic locations across the country. Sponsor 105 may desire to incentivize purchase of product 107 from one or more of the retail stores, and may customize criteria 118 indicating as such. For example, criteria 118 may indicate that any user within a five mile radius of a retail location who posts post 108 relevant to product 107, may receive purchase offer 116 for purchasing product from the closest retail store. Then for example, user 111 may redeem purchase offer 116 by visiting the designated retail store(s). Or, for example, purchase offer 116 may include only the location of a closest retail store, or an incentive to purchase product 107 online from a designated website.

MBS 102 may allow sponsor 105 of product 107 to utilize social-media posts 108 available through SMP 106 in real-time and without user intervention to provide users 111 purchase offers 116 to incentivize sales of product 107.

SMP 106 may include any platform or service that allows users 111 to communicate or interact with each other or the public through posts 108 or uploads of media 109 to the SMP 106. SMP 106 may be, for example, a website or service that allows users 111 to contribute media 109 via posts 108. Media 109 may include text, images, video, or other multimedia. SMP 106 may allow users to register with SMP 106 to post media 109 to SMP, and allow other users 111 or the public to view, use, or otherwise access posts 108. For example, a registered user 111 may take an image (media 109) with a cell phone camera and provide or post the image to SMP 106 as post 108 for other users to see or access. In addition to posting the picture, user 111 may also be able to provide text or a description that describes or categorizes the picture (e.g., markup tag 112). Post 108 may include media 109 and optionally include one or more markup tags 112.

As referenced above, sponsor 105 may be any entity seeking to offer product 107. In the example provided above, sponsor 105 may be a shoe company desiring to launch a new line of sneakers (product 107). However it is understood that such an embodiment is exemplary only, and that system 100 may be used in numerous other circumstances with different types of sponsors 105 and products 107 as well. For example, sponsor 105 may be an accounting company that desires to offer a new tax service (product 107), a computer company that desires to offer a new software release (product 107), an author who is offering a published book or article (product 107), or a candidate for public office (sponsor 105) desiring to incentivize donations to his/her campaign (product 107).

Sponsor 105 may provide information for offer strategy 104 that may include decisions or strategy on how to offer product 107 using SMP 106. MBS 102 may then implement offer strategy 104 on SMP 106. MBS 102 may monitor SMP 106 for posts 108 that include markup tag 112 as defined or provided by offer strategy 104.

Markup tag 112 may be a social media marker, keyword, or text used to identify, categorize, or otherwise describe post 108 or media 109 of post 108 on SMP 106, such as, for example, a hashtag. Markup tag 112 may be used by users 111 to convey a context of media 109, or may otherwise allow post 108 to be more easily searched for, identified, or categorized. For example, markup tag 112 may be included with or otherwise associated with post 108 to indicate the subject matter, event, or category of post 108. Markup tag 112 may be used, for example, to describe a known location or event, such as “#NYC” or “#ThanksgivingParade.”

In an embodiment, markup tag 112 may include a designated symbolic character portion (char) 112A and an alphanumeric tag description portion (tag) 112B. Char 112A may be a symbol or other character that indicates that a markup tag is present. For example, as is commonly known char 112A may Le a hash “#” symbol. In additional embodiments, char 112A may be a dollar sign “$”, percent “ %”, caret “̂”, asterisk “*”, ampersand (“&”) or other symbol, or combination of symbols. In an embodiment, each different char 112A used in markup tag 112 is be associated with a different, intent, of what information is being conveyed by tag 112B with regard to post 108.

Tag 112B may be a description of whatever information user 111 intends to convey with post 108 in the context or intent of char 112A. Char 112A “#” may be a general indicator for a categorization or description of tag 112B. In an embodiment, tag 112B may be a well-known designation used to describe media 109 of post 108. For example, a user may post a picture (media 109) taken at a sports event with markup tag 112 “#FightingEagles,” in which “Fighting Eagles” is the name of one of the competing sports teams and is used as tag 112B. Or, for example, user 111 may post a video (media 109) from a newsworthy event or story, such as a court case, election, or natural disaster, with a markup tag 112 “#PresidentialElection,” for an election. In an embodiment, there are no space characters separating char 112A from tag 112B in markup tag 112. Tag 112B may be whatever searchable alphanumeric or symbolic description user 111 desires to associate with post 108.

Monitor 130 may use markup tag 112, as provided within the context of offer strategy 104, to identify posts 108 to SMP 106 relevant to the offering of product 107. Markup tag 112 of offer strategy 104 may specify both char 112A and tag 112B that are relevant to the offering of product 107. For example, a shoe company may be launching a new sneaker line called “Super Sneaker,” and via offer strategy 104 may provide markup tag 112 “% SuperSneaker” and/or “% SuperShoe.” Monitor 130 may then monitor SMP 106 for posts 108 with markup tags matching markup tag 112 “% SuperSneaker” and/or “% SuperShoe,” while ignoring markup tags 112 with different chars 112A, such as “#”. Or for example, monitor 130 may detect “#SuperSneaker” aid provide purchase offer 116 that varies from “#SuperShoe.”

Platform 114 may indicate to which SMP(s) 106 to direct or provide offer strategy 104. For example, there may be available various SMPs 106 directed to different social media purposes. For example, a first SMP 106 may be directed to allowing users to develop business connections, while another may primarily feature social interactions. Platform 114 may indicate to which SMP(s) offer strategy 104 is to be directed.

In an embodiment, each SMP 106 may have its own unique markup tag 112 format. For example, markup tag 112 for a first SMP 106 may include a first char 112A, while markup tag 112 for another SMP 106 may not include char 112A, and may only include tag 112B or may include a different char 112A. In an embodiment, if multiple SMPs 106 are designated with platform 114, then each SMP 106 may have its own markup tag 112 designation(s).

Monitor 130 may perform real-time monitoring, scanning, and/or parsing of SMP 106 for posts 108 including markup tag 112 and media 109 in accordance with offer strategy 104. For example, monitor 130 may monitor SMP 106 for posts 108 that include markup tag 112 “#SuperShoe” in accordance with offer strategy 104. In an embodiment, criteria 118 may also include a specification on which type of media 109 is to be included with post 108 for purchase offer 116 to be provided.

Media 109 may include images, video, text, or other multimedia. In an embodiment, offer strategy 104 may include a media-type that specifies which selection of a type, combination of types, or limitations on types of media 109 relevant to offering product 107. For example, the media-type may specify images (e.g., still images), panoramic images, video, video or images less than a particular file size or greater than a particular file size, text, text and images, text less than a specified number of characters, or media of specified file format.

In an embodiment, monitor 130 may further narrow monitoring results of posts 108 from SMP 106 by the specified media-type. For example, offer strategy 104 may indicate media type 116 of still images with a file size greater than 10 MB and less than 50 MB. Then for example, upon detection of post 108 with markup tag 112 “% SuperShoe,” monitor 130 may farther determine whether the post 108 includes still image media 109, and whether the still image media has a file size greater than 10 MB and less than 50 MB. In an embodiment, monitor 130 may be able to access or monitor posts 108 on SMP 106 using an application programming interface (API) for SMP 106.

After a detection of one or more posts 108 matching markup tag 112 by monitor 130, extractor 132 may extract or request media 109 and user info 124 associated with post 108 from SMP 106. User info 124 may include any user information collected by SMP 106 as provided by or about a user who posts 108 to SMP 106 and made available or accessible to MBS 102. User info 124 may include a username 124A, a location 124B, and connections 124C. User info 124 may also include other information such as a name, age, birthdate, previous posts or user activity information, a device-used, phone number, or other information. In an embodiment, a user may need to consent for SMP 106 to release this information, a subset thereof, or other information to MBS 102.

Username 124A may be a user-provided name or identifier, such as an e-mail address, legal name, or other identifier, used by SMP 106 to identify user 111. Username 124A may be associated with posts 108 by user 111. Location 124B may be a most recent location from where user 111 checked-in to a location or business, or a GPS indicator of an approximate position from where user 111 is located or from where user 111 posted post 108. Connections 124C may include an indication of user's 111 social network. For example, corn ections 124C may include an indication of which other users 111 or how many other users 111 are connected to a particular user 111 through SMP 106. In an embodiment, when user 111 posts post 108 to SMP 106, post 108 may be made available to connections 124C who may view or comment on post 208. Similarly, a particular user 111 may view posts 108 from other users 111 to whom the particular user 111 is connected.

As referenced above, criteria 118 may include limitations for filtering posts 108 or providing purchase offer 116 to users 111 who meet particular or defined user info 124 settings or values. For example, criteria 118 may include an indication to only provide purchase offers to users 111 who post about product 107 with an indication to purchase (e.g., “%” char 112A) with more than 100 connections 124C. Or, for example, criteria 118 may specify that the size of purchase offer 116 will be based on the number of connections 124C and location 124B. Upon detection of such a post 108, using the SMP API, extractor 132 may extract, request or otherwise access to media 109, user info 124, and other content of post 108 that may be made available by SMP 106.

In an embodiment, different chars 112A may allow users of SMP 106 to convey a different intent for markup tag 112 of posts 108, including modifying or editing the posted media 108. For example, while hash (“#”) may allow a user to describe or categorize post 108, percent (“%”) may indicate an intent to purchase or inquire about purchasing product 107. For example, a user may take a picture of a shoe someone is wearing. The user may then upload the picture (media 109) to SMP 106 with a markup tag 112 that reads “% SuperShoe,” or “% ShoesAndStuff.” Monitor 130 may identify the “%” char 112A as an intent to purchase product 107 (“Super Shoe) which is identified in media 109 or tag 112B, or an intent to purchase an item offered by sponsor 105 (“Shoes And Stuff”).

In a further embodiment, the user may use multiple markup tags 112 with different chars 112A, or combine chars 112A into a single markup tag 112. For example post 108 may include markup tags 112 “% SuperShoe” and “#ShoesAndStuff,” Or, for example, post 108 may include markup tag 112 “#% SuperShoe.” Monitor 130 may then recognize the markup tag 112 as both, a categorization and intent to purchase product 107.

MBS 102 may allow sponsor 105 to customize how social media is to be used to brand, market, or promote product 107. Based on brand strategy 104, MBS 102 may, in real-time and without user intervention, monitor SMPs 106 for posts 108 of interest to sponsor 105. MBS 102 may further respond to and provide purchase offers 116 to qualified users 111 (e.g., that meet criteria 118). In an embodiment, MBS 102 may be used to monitor multiple SMPs 106 for different sponsors 105, each of which may have one or more offer strategies 104 for any number of brands or products 107.

FIG. 2 is a flowchart of a process 200 for providing social media purchase offers, according to an example embodiment. The stages of FIG. 2 are described below, in non-limiting examples, with reference to FIG. 1.

At stage 210, an offer strategy construct is received. For example, MBS 102 may receive offer strategy 104. Offer strategy 104 may be, for example, a portion of a marketing or sales strategy for a new product line or service sponsor 105 desires to promote. Sponsor 105 may provide various preferences or values for which markup tag(s) 112 associated with a social media platform (SMP) are relevant to product 107, purchase offer 116, and criteria 118 for providing the purchase offer 116 in response to post 108 to SMP 106. Sponsor 105 may further specify which platform 114 (i.e., SMPs 106) should be monitored for markup tag 112.

At stage 220, posts to a social-media platform are monitored for markup tags corresponding to the offer strategy. For example, monitor 130 may monitor posts 108 to SMP 106 from all, or a subset of users of SMP 106. Monitor 130 may, in real-time, or close to real-time, monitor posts 108 to SMP 106 from all the users or a subset of users of SMP 106, for posts 108 with a markup tag 112 that corresponds to markup tag 112 as specified by offer strategy 104. Upon detection of markup tag 112, monitor 130 may further determine whether posts 108 have media 109 of a specified media type of offer strategy 104 as may be provided in criteria 118.

At stage 230, a post corresponding to the markup tag is detected. For example, monitor 130 may parse posts 108 to SMP 106 for markup tags provided, in association with posts 108 for text or values corresponding or equivalent to markup tag 112 as specified by offer strategy 104.

At stage 240, user info is extracted from SMP 106. For example, extractor 112 may extract media 109 and user info 124 associated with post 108. In an embodiment, post 108 may include media 109 of varying media types (e.g., text, images, and video). Extractor 132, using API for SMP 106, may then extract or request only media 109 that corresponds to the specified media type of offer strategy 104 (if any). Extractor 132 may also extract or request user info 124 about which user provided or posted post 108 on SMP 106, if available.

At stage 250, it is determined that the user info satisfies the criteria. For example, verifier 134 may compare user info 124 associated with the detected post 108 against criteria 118. If user info 124 satisfies criteria 118, verifier 134 may determine or calculate which purchase offer 116 is provided to user 111. In an embodiment, if insufficient user info 124 is available, criteria 118 may provide a default action or purchase offer 116 to provide to user 111.

At stage 260, the purchase offer is provided to the user associated with the post. For example, verifier 134 may provide purchase offer 116 to user 111. In an embodiment, user 111 may specify how user 111 desires to receive purchase offer 116, or verifier 134 may post purchase offer 116 to SMP 106 for access by user 111 and/or one or more of other users connected to user 111.

FIG. 3 illustrates an example computer system 300 in which embodiments as described herein, or portions thereof, may be implemented as computer-readable code. For example, MBS 102, including portions thereof, may be implemented in computer system 300 using hardware, software, firmware, tangible computer readable media having instructions stored thereon, or a combination thereof and may be implemented in one or more computer systems or other processing systems. Hardware, software, or any combination of such may embody any of the modules, procedures and components in FIGS. 1-2.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

Various embodiments are described in terms of this example computer system 300. After reading this description, it will become apparent to a person skilled in the relevant art how to implement the embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 304 may be a single processor in a multi-core/multiprocessor system, such system may be operating alone, or in a cluster of computing devices operating in a cluster or server farm. Processor device 304 is connected to a communication infrastructure 306, for example, a bus, message queue, network, or multi-core message-passing scheme.

Computer system 300 also includes a main memory 308, for example, random access memory (RAM), and may also include a secondary memory 310. Main memory may include any kind at tangible memory. Secondary memory 310 may include, for example, a hard disk drive 312, removable storage drive 314. Removable storage drive 314 may comprise a floppy disk drive, a magnetic tape drive, an optical disk drive, a flash memory, or the like. The removable storage drive 314 reads from and/or writes to a removable storage unit 318 in a well-known manner. Removable storage unit 318 may include a floppy disk, magnetic tape, optical disk, etc. which is read by, and written to by removable storage drive 314. As will be appreciated by persons skilled in the relevant art, removable storage unit 318 includes a computer readable storage medium having stored therein computer software and/or data.

Computer system 300 (optionally) includes a display interface 302 (which can include input and output devices such as keyboards, mice, etc.) that forwards graphics, text, and other data from communication infrastructure 306 (or from a frame buffer not shown) for display on display unit 329.

In alternative implementations, secondary memory 310 may include other similar means for allowing computer programs or other instructions to be loaded into computer system 300. Such means may include, for example, a removable storage unit 322 and an interface 320. Examples of such means may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to computer system 300.

Computer system 300 may also include a communications interface 324. Communications interface 324 allows software and data to be transferred between computer system 300 and external devices. Communications interface 324 may include a modem, a network interface (such as an Ethernet card), a communications port, a PCMCIA slot and card, or the like. Software and data transferred via communications interface 324 may be in the form of signals, which may be electronic, electromagnetic, optical, or other signals capable of being received by communications interface 324. These signals may be provided to communications interface 324 via a non-storage capable communications path 326. Communications path 526 carries signals and may be implemented using wire or cable, fiber optics, a phone line, a cellular phone link, an RF link or other communications channels.

In this document, the terms “computer storage medium” and “computer readable storage medium” are used to generally refer to media such as removable storage unit 318, removable storage unit 322, and a hard disk installed in hard disk drive 312. Computer storage medium and computer readable storage medium may also refer to memories, such as main memory 308 and secondary memory 310, which may be memory semiconductors (e.g. DRAMs, etc.).

Computer programs (also called computer control logic) are stored in main memory 308 and/or secondary memory 310. Computer programs may also be received via communications interface 324. Such computer programs, when executed, enable computer system 300 to implement embodiments as discussed herein. Where the embodiments are implemented using software, the software may, be stored in a computer program product and loaded into computer system 300 using removable storage drive 314, interface 320, and hard disk drive 312, or communications interface 324.

Embodiments also may be directed to computer program products comprising software stored on any computer readable medium. Such software, when executed in one or more data processing device, causes a data processing device(s) to operate as described herein. Embodiments may employ any computer readable storage medium. Examples of computer readable storage mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The Summary and Abstract sections may set forth one or more but not all exemplary embodiments as contemplated by the inventor(s), and thus, are not intended to limit the described embodiments of the appended claims in any way.

Various embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept as described herein. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described examples, but should be defined only in accordance with the following claims and their equivalents.

What is claimed is:

1. A system comprising:
a monitor configured to receive an offer strategy construct, the offer strategy construct including: a markup tag associated with a social media platform (SMP), a purchase offer, and criteria for providing the purchase offer in response to a post to the SMP;
the monitor configured to monitor the SMP for posts corresponding to the markup tag, wherein the monitor is further configured to detect that a particular post with the corresponding markup tag is posted to the SMP;
an extractor configured to extract user info associated with the post from the SWP, wherein the user info provides information about a user who provided the particular post to the SMP; and
a verifier configured to provide the purchase offer to the user associated with the post as determined from the user info upon determining that the user info satisfies the criteria.

2. The system of claim 1, wherein the purchase offer includes an incentive to purchase a product associated with the markup tag.

3. The system of claim 1, wherein the purchase offer is only redeemable by the user associated with the post.

4. The system of claim 1, wherein the markup tag comprises a designated symbolic character indicating an intent to purchase the product, and an alpha-numeric tag description that identifies the product.

5. The system of claim 4, wherein the designated symbol character comprises a percent sign.

6. The system of claim 1, wherein the markup tag, comprises a designated symbolic character indicating an intent to purchase the product as is included in media associated with the post.

7. The system of claim 6, wherein the markup tag includes an alpha-numeric tag description that identifies a sponsor of the product.

8. The system of claim 1, wherein the verifier is further configured to provide the purchase offer to the user via the SMP.

9. A method comprising:
receiving an offer strategy construct, the offer strategy construct including: a markup tag associated with a social media platform (SMP), a purchase offer, and criteria for providing the purchase offer in response to a post to the SMP;
monitoring the SMP for posts corresponding to the markup tag;
extracting user info from the SMP upon a detection that a particular post corresponds to the markup tag, wherein the user info provides information about a user who provided the particular post to the SMP;
determining whether the user info satisfies the criteria; and
providing the purchase offer to the user associated with the post as determined from the user info upon a determination that the user info satisfies the criteria.

10. The method of claim 9, wherein the purchase offer includes an incentive to purchase a product associated with the markup tag.

11. The method of claim 9, wherein the user info includes the username of a user who provided the post to the SMP, a location of a user device when the post was made, and connections indicating a SMP network size of how many other users of the SMP the username is connected to through the SMP.

12. The method of claim 9, wherein the purchase offer is only redeemable by the user associated with the post.

13. The method of claim 9, wherein the markup tag comprises a designated symbolic character indicating an intent to purchase the product, and an alpha-numeric tag description associated that identifies the product intended to be purchased.

14. The method of claim 13, wherein the designated symbol character comprises a “%”.

15. The method of claim 9, wherein the markup tag comprises a designated symbolic character indicating an intent to purchase the product as included in media associated with the post.

16. The method of claim 9, wherein the providing comprises providing the purchase offer to the user via the SMP.

17. The method of claim 11, wherein the providing comprises providing, the purchase offer to the user and one or more of the other users connected to the user via the SMP.

18. A computer program product implemented on one or more processors and a tangible memory accessible to the one or more processors, the memory comprising code that when executed cause the one or more processors to:
receive an offer strategy construct, the offer strategy construct including: a markup tag associated with a social media platform (SMP), a purchase offer, and criteria for providing the purchase offer in response to a post to the SMP;
monitor the SMP for posts corresponding to the markup tag;
detect that a particular post with the corresponding markup tag is posted to the SMP;
extract user info associated with the post from the SMP, wherein the user info provides information about a user who provided the particular post to the SMP;
determine that the user info satisfies the criteria; and
provide the purchase offer to the user associated with the post as determined from the user info.

19. The computer program product of claim 18, wherein markup tag comprises a designated symbolic character comprising a percent sign that indicates an intent to purchase an item associated, with at least one of an alpha-numeric tag description associated with the designated symbolic character, or media associated with the designed symbolic character.

20. The computer program product of claim 18, wherein the code when executed is further configured to:
provide the purchase offer to the user via the SMP.
